(19) United States
(12) Patent Application Publication
(10) Pub. No.: US 2020/0412773 A1
(43) Pub. Date: Dec. 31, 2020

(54) METHOD AND APPARATUS FOR GENERATING INFORMATION

(71) Applicant: Beijing Baidu Netcom Science and Technology Co., Ltd., Beijing (CN)

(72) Inventors: Lihao Wang, Beijing (CN); Jianbin He, Beijing (CN); Shikang Kong, Beijing (CN); Zhensheng Cai, Beijing (CN)

(21) Appl. No.: 16/721,769

(22) Filed: Dec. 19, 2019

(30) Foreign Application Priority Data
Jun. 28, 2019 (CN) 201910573596.7

(51) Int. Cl. H04L 29/06; H04L 29/08; H04N 7/15; H04L 12/18; H04L 12/58

(52) U.S. Cl. CPC H04L 65/403; H04L 67/14; H04L 12/1827; H04L 12/1822; H04L 51/04; H04N 7/15

(57) ABSTRACT

Embodiments of the present disclosure provide a method and apparatus for generating information, and relate to the field of cloud computation. The method may include: receiving a video and an audio of a user that are sent by a client by means of instant communication; generating user feature information and text reply information according to the video and the audio; generating a control parameter and a reply audio for a three-dimensional virtual portrait according to the user feature information and the text reply information; generating a video of the three-dimensional virtual portrait by means of an animation engine based on the control parameter and the reply audio; and transmitting the video of the three-dimensional virtual portrait to the client by means of instant communication, for the client to present to the user.

### CROSS-REFERENCE TO RELATED APPLICATIONS

This application claims priority to Chinese Application No. 201910573596.7, filed on Jun. 28, 2019 and entitled “Method and Apparatus for Generating Information,” the entire disclosure of which is hereby incorporated by reference.

### TECHNICAL FIELD

Embodiments of the present disclosure relate to the field of computer technology, and specifically to a method and apparatus for generating information.

### BACKGROUND

At the present stage, intelligent services have been applied to various fields. For example, in an application scenario such as intelligent customer services or a telephone robot, a user and a terminal used thereby may interact by means of a text dialog box or a simple speech. Such interaction is traditional and blunt, and the degree of humanization and user experience are poor. By rendering a three-dimensional virtual portrait, the virtual portrait technology may provide more convenient use experience of intelligent service, thereby improving the anthropomorphic degree of a three-dimensional virtual portrait when the user interacts with the three-dimensional virtual portrait. Although the existing virtual portrait technologies have a high anthropomorphic effect, most of them still remain in scripted application scenarios, and may only respond to designed actions as instructed, but the ability thereof in interpreting the motion, intention or the like of the user is poor. Therefore, the reply to the user during interaction may not meet the actual demands of the user sometimes.

### SUMMARY

Embodiments of the present disclosure propose a method and apparatus for generating information.

In a first aspect, an embodiment of the present disclosure provides a method for generating information, the method including: receiving a video and an audio of a user that are sent by a client by means of instant communication; generating user feature information and text reply information according to the video and the audio; generating a control parameter and a reply audio for a three-dimensional virtual portrait according to the user feature information and the text reply information; generating a video of the three-dimensional virtual portrait by means of an animation engine based on the control parameter and the reply audio; and transmitting the video of the three-dimensional virtual portrait to the client by means of instant communication, for the client to present to the user.

In some embodiments, the generating user feature information and text reply information according to the video and the audio includes: identifying the video to obtain user feature information, and identifying the audio to obtain text information; acquiring relevant information, the relevant information including historical user feature information and historical text information; and generating text reply information based on the user feature information, the text information and the relevant information.

In some embodiments, the method further includes: storing the user feature information and the text information in association into a session information set that is set for a current session.

In some embodiments, the acquiring relevant information includes: acquiring relevant information from the session information set.

In some embodiments, the user feature information includes a user expression; and the generating a control parameter and a reply audio for a three-dimensional virtual portrait according to the user feature information and the text reply information includes: generating the reply audio according to the text reply information; and generating the control parameter for the three-dimensional virtual portrait according to the user expression and the reply audio.

In a second aspect, an embodiment of the present disclosure provides an apparatus for generating information, the apparatus including: a receiving unit, configured for receiving a video and an audio of a user that are sent by a client by means of instant communication; a first generation unit, configured for generating user feature information and text reply information according to the video and the audio; a second generation unit, configured for generating a control parameter and a reply audio for a three-dimensional virtual portrait according to the user feature information and the text reply information; a third generation unit, configured for generating a video of the three-dimensional virtual portrait by means of an animation engine based on the control parameter and the reply audio; and a transmission unit, configured for transmitting the video of the three-dimensional virtual portrait to the client by means of instant communication, for the client to present to the user.

In some embodiments, the first generation unit includes: an identification unit, configured for identifying the video to obtain user feature information, and identifying the audio to obtain text information; an acquisition unit, configured for acquiring relevant information, the relevant information including historical user feature information and historical text information; and an information generation unit, configured for generating text reply information based on the user feature information, the text information and the relevant information.

In some embodiments, the apparatus further includes: a storage unit, configured for storing the user feature information and the text information in association into a session information set that is set for a current session.

In some embodiments, the acquisition unit is further configured for: acquiring relevant information from the session information set.

In some embodiments, the user feature information includes a user expression; and the second generation unit is further configured for: generating the reply audio according to the text reply information; and generating the control parameter for the three-dimensional virtual portrait according to the user expression and the reply audio.

In a third aspect, an embodiment of the present disclosure provides a device, the device including: one or more processors; and a storage apparatus, storing one or more programs, where the one or more programs, when executed by the one or more processors, cause the one or more processors to implement any implementation of the method according to the first aspect.

In a fourth aspect, an embodiment of the present disclosure provides a computer readable medium, storing a computer program thereon, where the computer program, when executed by a processor, implements any implementation of the method according to the first aspect.

The method and apparatus for generating information provided by embodiments of the present disclosure include: first, receiving a video and an audio of a user that are sent by a client by means of instant communication; second, generating user feature information and text reply information according to the video and the audio; and then, generating a control parameter and a reply audio for a three-dimensional virtual portrait according to the user feature information and the text reply information; and then, generating a video of the three-dimensional virtual portrait by means of an animation engine based on the control parameter and the reply audio; and finally, transmitting the video of the three-dimensional virtual portrait to the client by means of instant communication, for the client to present to the user. Therefore, the generation and rendering of the video of the three-dimensional virtual portrait are performed in a backend server, which reduces the occupation of the client and improves the response speed of the client. At the same time, the interaction between the client and the backend server is realized by means of instant communication, the real time performance of the interaction between the client and the backend server is improved, and the response speed of the client is thus improved.

### BRIEF DESCRIPTION OF THE DRAWINGS

After reading detailed descriptions of non-limiting embodiments with reference to the following accompanying drawings, other features, objectives and advantages of the present disclosure will become more apparent.

FIG. 1 is a diagram of an example system architecture in which embodiments of the present disclosure may be implemented;

FIG. 2 is a flowchart of a method for generating information according to an embodiment of the present disclosure;

FIG. 3 is a schematic diagram of an application scenario of the method for generating information according to an embodiment of the present disclosure;

FIG. 4 is a flowchart of the method for generating information according to another embodiment of the present disclosure;

FIG. 5 is a schematic structural diagram of an apparatus for generating information according to an embodiment of the present disclosure; and

FIG. 6 is a schematic structural diagram of a computer system adapted to implement a sever of embodiments of the present disclosure.

### DETAILED DESCRIPTION OF EMBODIMENTS

Embodiments of present disclosure will be described below in detail with reference to the accompanying drawings. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that some embodiments in the present disclosure and some features in the disclosure may be combined with each other on a non-conflict basis. Features of the present disclosure will be described below in detail with reference to the accompanying drawings and in combination with embodiments.

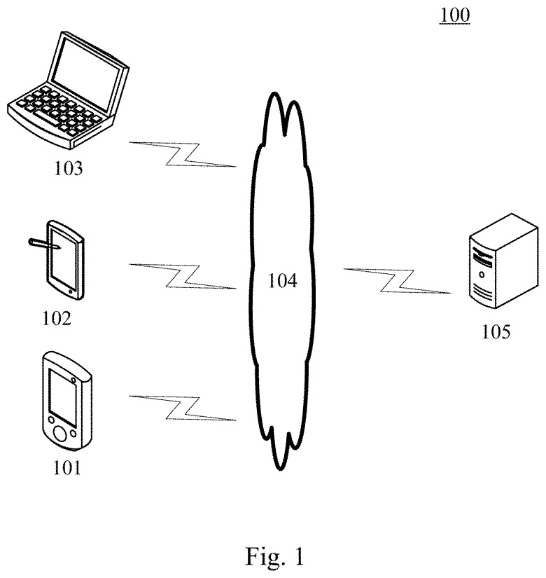

FIG. 1 shows an example system architecture 100 in which a method for generating information or an apparatus for generating information according to an embodiment of the present disclosure may be implemented.

As shown in FIG. 1, the system architecture 100 may include terminal devices 101, 102, 103, a network 104, and a server 105. The network 104 serves as a medium providing a communication link between the terminal devices 101, 102, 103, and the server 105. The network 104 may include various types of connections, such as wired or wireless communication links, or optical fibers.

A user may interact with the server 105 by using the terminal device 101, 102 or 103 through the network 104 to receive or send messages, etc. The terminal device 101, 102 or 103 may be installed with various communication client applications, such as chat bot applications, web browser applications, shopping applications, search applications or instant messaging tools.

The terminal devices 101, 102 and 103 may be hardware or software. When the terminal devices 101, 102 and 103 are hardware, the terminal devices may be various electronic devices having display screens, video acquisition devices (such as cameras), audio acquisition devices (such as microphones) or the like, including but not limited to a smart phone, a tablet computer, a laptop portable computer and a desktop computer. When the terminal devices 101, 102 and 103 are software, the terminal devices may be installed in the above-listed electronic devices. The terminal device may be implemented as a plurality of software programs or software modules (e.g., software programs or software modules for providing distributed services), or as a single software program or software module, which is not specifically limited here.

The server 105 may provide various services, such as a backend server providing supports for a three-dimensional virtual portrait displayed on the terminal devices 101, 102 or 103. The backend server may analyze received videos and audios, and return a processing result (for example, a video of the three-dimensional virtual portrait) to the terminal devices 101, 102 or 103.

It should be noted that the server 105 may be hardware or software. When the server 105 is hardware, the server may be implemented as a distributed server cluster composed of a plurality of servers, or may be implemented as a single server. When the server 105 is software, the server may be implemented as a plurality of software programs or software modules (such as software programs or software modules for providing distributed services), or may be implemented as a single software program or software module, which is not specifically limited here.

It should be understood that the numbers of the terminal devices, network and server in FIG. 1 are merely illustrative. Any number of terminal devices, networks and servers may be provided based on actual requirements.

It should be noted that the method for generating information provided by embodiments of the present disclosure is generally executed by the server 105, and the apparatus for generating information is generally provided in the server 105.

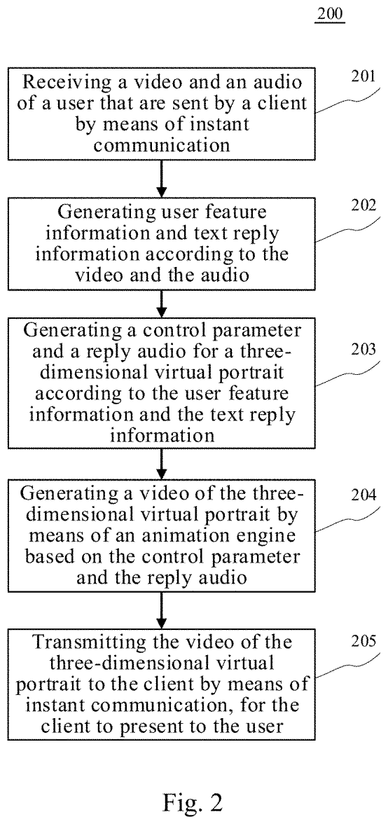

Referring to FIG. 2, a flow 200 of a method for generating information according to an embodiment of the present disclosure is shown. The method for generating information comprises the following steps.

Step 201: receiving a video and an audio of a user that are sent by a client by means of instant communication.

In the present embodiment, an executing body (for example, the server 105 shown in FIG. 1) of the method for generating information may receive a video and an audio of a user from a client by means of a wired connection or a wireless connection. The video and the audio of the user here may be sent by the client by means of instant communication. As an example, the instant communication may be implemented by real-time communication (RTC), Web Real-Time Communication (WebRTC), or the like.

Generally, the user may perform information interaction using a client installed in a terminal (for example, the terminal devices 101, 102, 103 shown in FIG. 1). The client may acquire the video, audio and other information of the user in real time, and transmit the acquired video, audio and other information to the executing body in real time by means of instant communication. The executing body here may be a backend server providing supports for the client. In this way, the backend server may process the video, audio and other information of the user in real time.

Step 202: generating user feature information and text reply information according to the video and the audio.

In the present embodiment, the executing body may generate user feature information and text reply information according to the video and audio obtained in step 201. Specifically, the executing body may perform various processing, such as gender recognition, age recognition, expression recognition, posture recognition, gesture recognition, dress recognition, on a video frame of the video, so as to obtain user feature information. The executing body may perform various processing on the audio. As an example, the executing body may first perform speech recognition on the audio to obtain text information corresponding to the audio. Thereafter, the executing body may generate text reply information according to the user feature information and the text information corresponding to the audio. For example, a chat bot may run in the executing body, so that the executing body may transmit the user feature information and the text information corresponding to the audio to the chat robot, and the chat robot feeds back the text reply information.

The chat bot here is a computer program that talks in the form of a dialogue or a text, and is able to simulate human conversations. The chat bot may be used for practical purposes, such as customer service and information acquisition. When information is inputted, the chat bot may generate text reply information based on received information and a preset reply logic. In addition, the chat bot may also send a request including the received information to a preset device when a preset condition is met according to the preset logic. In this way, a user (such as a professional service person) using the device may generate text reply information based on the information in the request and return the generated text reply information to the chat bot.

Step 203: generating a control parameter and a reply audio for a three-dimensional virtual portrait according to the user feature information and the text reply information.

In the present embodiment, the executing body may generate a control parameter and a reply audio for a three-dimensional virtual portrait according to the user feature information and the text reply information. Specifically, the executing body may convert the text reply information into a reply audio by means of TTS (Text To Speech). As an example, in converting the text reply information into a reply audio, the executing body may set certain characteristics, such as tone, speech rate and timbre (such as male voice, female voice, Child's voice), of the converted reply audio based on the user feature information. The executing body here may prestore a corresponding relationship between the user feature information and the characteristic of the reply audio. For example, the speech rate of the reply audio from a younger user may be reduced. Thereafter, the executing body may generate a control parameter of the three-dimensional virtual portrait based on the user feature information and the reply audio. The three-dimensional virtual portrait here may be developed by an animation engine, which may include but not limited to a UE4 (Unreal Engine 4), Maya and Unity 3D. The drive of the three-dimensional virtual portrait may be controlled by some predefined parameters. As an example, the executing body may preset a correspondence rule between the user feature information and a facial expression of the three-dimensional virtual portrait, and a correspondence rule between the audio and the mouth shape change, limb movement or the like of the three-dimensional virtual portrait. In this way, the executing body may determine the parameter for controlling the drive of the three-dimensional virtual portrait based on the user feature information and the reply audio.

In some optional implementations of the present embodiment, the user feature information may include a user expression, and step 203 may be specifically performed as follows.

First, generating a reply audio according to the text reply information.

In the present implementation, the executing body may convert the text reply information into a reply audio by means of TTS. As an example, in converting the text reply information into a reply audio, the executing body may set certain characteristics, such as tone, speech rate and timbre (such as male voice, female voice, Child's voice), of the converted reply audio based on the user feature information.

And then, generating a control parameter for a three-dimensional virtual portrait according to the user expression and the reply audio.

In the present implementation, the executing body may recognize the user expression by expression recognition. For example, the executing body may recognize various expressions such as happiness, anger, surprise, fear, disgust and sadness. The executing body may generate a control parameter for a three-dimensional virtual portrait based on the user expression and the reply audio. As an example, the executing body may preset a correspondence rule between the user feature information and the facial expression of the three-dimensional virtual portrait, and a correspondence rule between the audio and the mouth shape change, limb movement or the like of the three-dimensional virtual portrait. In this way, the executing body may determine the parameters for controlling the drive of the three-dimensional virtual portrait based on the user feature information and the reply audio.

Step 204: generating a video of the three-dimensional virtual portrait by means of a render engine based on the control parameter and the reply audio.

In the present embodiment, the executing body may transmit the control parameter and the reply audio generated in step 203 to the animation engine. The animation engine may render the video (animation) of the three-dimensional virtual portrait according to the received control parameter and the reply audio in real time, and feed the rendered real-time video back to the executing body. The video of the three-dimensional virtual portrait that is rendered by the animation engine is a video comprising an audio.

Step 205: transmitting the video of the three-dimensional virtual portrait to the client by means of instant communication, for the client to present to the user.

In the present embodiment, the executing body may transmit the video of the three-dimensional virtual portrait that is generated in step 204 to the client by means of instant communication, for the client to present to the user.

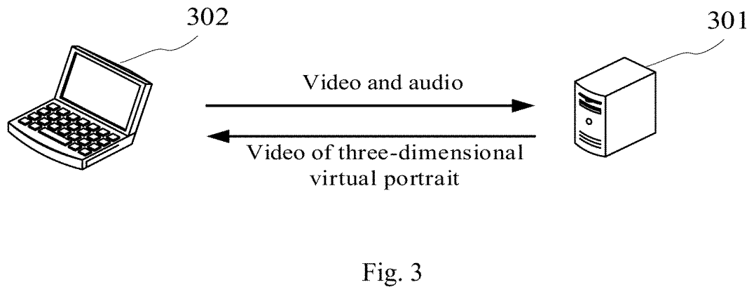

Further referring to FIG. 3, a schematic diagram of an application scenario of the method for generating information according to the present embodiment is shown. In the application scenario of FIG. 3, the server 301 first receives a video and an audio of a user that are transmitted by a client 302 by means of instant communication. Next, the server 301 generates user feature information and text reply information based on the video and the audio. Thereafter, the server 301 generates a control parameter and a reply audio for a three-dimensional virtual portrait based on the generated user feature information and the text reply information. Then, the server 301 generates a video of the three-dimensional virtual portrait by means of an animation engine based on the control parameter and the reply audio. Finally, the server 301 may transmit the video of the three-dimensional virtual portrait to the client 302 by means of instant communication, for the client 302 to present to the user.

The method provided by embodiments of the present disclosure analyzes and processes the video and audio of the user acquired by the client by means of a backend server, and obtains user feature information and text reply information so as to generate the video of the three-dimensional virtual portrait, and transmits the video of the three-dimensional virtual portrait to the client. Therefore, the generation and rendering of the video of the three-dimensional virtual portrait are performed in the backend server, which reduces the occupation of the client and improves the response speed of the client. At the same time, the interaction between the client and the backend server is realized by means of instant communication, the real time performance of the interaction between the client and the backend server is improved, and the response speed of the client is further improved.

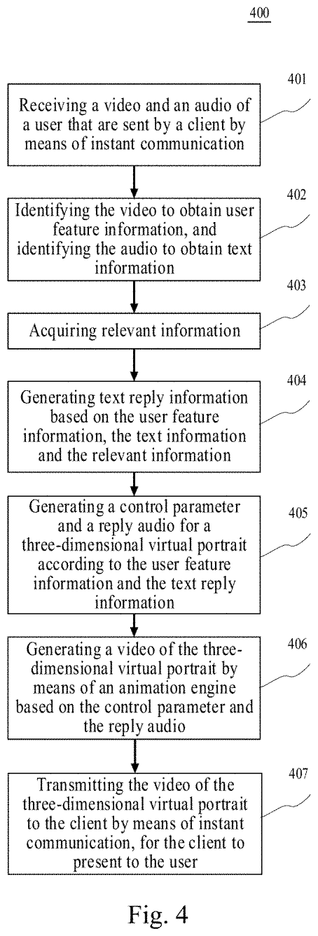

Further referring to FIG. 4, a flow 400 of another embodiment of the method for generating information is shown. The flow 400 of the method for generating information includes the following steps.

Step 401: receiving a video and an audio of a user that are sent by a client by means of instant communication.

In the present embodiment, step 401 is basically consistent with step 201 in the embodiment shown in FIG. 2, and such step will not be repeated here.

Step 402: identifying the video to obtain user feature information, and identifying the audio to obtain text information.

In the present embodiment, an executing body may perform various processing, such as gender recognition, age recognition, expression recognition, posture recognition, gesture recognition and dress recognition, on a video frame of the video received in step 401, so as to obtain user feature information. The executing body may perform speech recognition on the audio received in step 401 to obtain text information corresponding to the audio.

Step 403: acquiring relevant information.

In the present embodiment, the executing body may acquire relevant information. The relevant information herein may include historical user feature information and historical text information. The historical user feature information and the historical text information here may be generated based on a historical video and a historical audio of the user that are transmitted by the client. The historical video and the historical audio of the user here may have a context relationship with the video and audio of the user that are received in step 401, for example, a context that belongs to the same session. Here, a session is created when the client used by the user interacts with the server (i.e., the executing body).

In some optional implementations of the present embodiment, the method for generating information may further comprise: storing the user feature information and the text information in association into a session information set that is set for a current session.

In the present implementation, the executing body may store the user feature information and the text information that are acquired in step 402 in association into a session information set that is set for a current session. In practice, when the client sends a message (possibly including a video and an audio) to the executing body, the executing body determines whether the message includes a session identifier (sessionID). If the message does not include a session identifier, the executing body may generate a session identifier for the message and store various information generated by the session process and the session identifier in association into a session information set. If the message includes a session identifier and the included session identifier does not expire, a session information set corresponding to the session identifier may be used directly, for example, for information storage or information acquisition.

In some optional implementations of the present embodiment, step 403 may be executed as follows: acquiring relevant information from a session information set.

In the present implementation, the executing body may acquire relevant information from the session information set. For example, the executing body may acquire the latest preset pieces of information stored in the session information set as relevant information.

Step 404: generating text reply information based on the user feature information, the text information and the relevant information.

In the present embodiment, the executing body may generate text reply information based on the user feature information, the text information and the relevant information. The executing body may transmit the user feature information, the text information and the relevant information to a running chat bot. Hence, the chat bot may comprehensively analyze the user feature information, the text information and the relevant information, so as to generate more accurate text reply information.

Step 405: generating a control parameter and a reply audio for a three-dimensional virtual portrait according to the user feature information and the text reply information.

In the present embodiment, step 405 is basically consistent with step 203 in the embodiment shown in FIG. 2, and such step will not be repeated here.

Step 406: generating a video of the three-dimensional virtual portrait by means of an animation engine based on the control parameter and the reply audio.

In the present embodiment, step 406 is basically consistent with step 204 in the embodiment shown in FIG. 2, and such step will not be repeated here.

Step 407: transmitting the video of the three-dimensional virtual portrait to the client by means of instant communication, for the client to present to the user.

In the present embodiment, step 407 is basically consistent with step 205 in the embodiment shown in FIG. 2, and such step will not be repeated here.

As shown in FIG. 4, compared with the embodiment corresponding to FIG. 2, the flow 400 of the method for generating information in the present embodiment highlights the steps of acquiring the relevant information and generating text reply information based on the user feature information, the text information and the relevant information. Therefore, the solution described in the present embodiment may comprehensively analyze the user feature information, the text information and the relevant information, so that the generated text reply information is more accurate, and the reply of the three-dimensional virtual portrait to the user is thus more accurate, thereby improving the user experience.

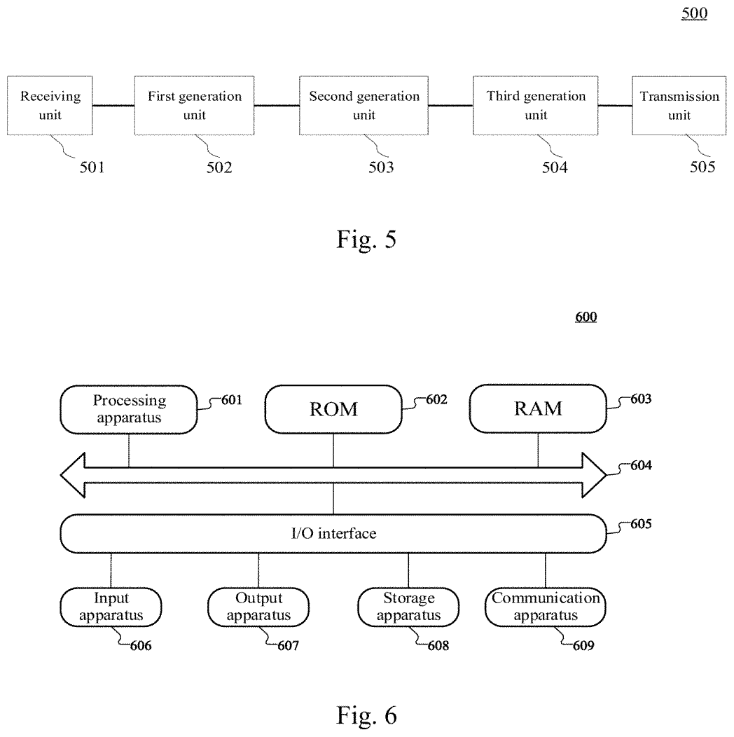

Further referring to FIG. 5, as an implementation of the method shown in each figure, an embodiment of the present disclosure provides an apparatus for generating information. The apparatus embodiment may correspond to the method embodiment shown in FIG. 2, and the apparatus may be specifically applied to various electronic devices.

As shown in FIG. 5, the apparatus 500 for generating information according to the present embodiment comprises a receiving unit 501, a first generation unit 502, a second generation unit 503, a third generation unit 504 and a transmission unit 505. The receiving unit 501 is configured for receiving a video and an audio of a user that are sent by a client by means of instant communication; the first generation unit 502 is configured for generating user feature information and text reply information according to the video and the audio; the second generation unit 503 is configured for generating a control parameter and a reply audio for a three-dimensional virtual portrait according to the user feature information and the text reply information; the third generation unit 504 is configured for generating a video of the three-dimensional virtual portrait by means of an animation engine based on the control parameter and the reply audio; and the transmission unit 505 is configured for transmitting the video of the three-dimensional virtual portrait to the client by means of instant communication, for the client to present to the user.

In the present embodiment, the specific processing of the receiving unit 501, the first generation unit 502, the second generation unit 503, the third generation unit 504 and the transmission unit 505 in the apparatus 500 for generating information and technical effects brought thereby may be respectively referred to steps 201, 202, 203, 204 and 205 in the corresponding embodiment shown in FIG. 2, and will not be repeated here.

In some optional implementations of the present embodiment, the first generating unit 502 comprises: an identification unit, configured for identifying the video to obtain user feature information, and identifying the audio to obtain text information; an acquisition unit, configured for acquiring relevant information, the relevant information comprising historical user feature information and historical text information; and an information generation unit, configured for generating text reply information based on the user feature information, the text information and the relevant information.

In some optional implementations of the present embodiment, the apparatus 500 further comprises a storage unit (not shown), configured for storing the user feature information and the text information in association into a session information set that is set for a current session.

In some optional implementations of the present embodiment, the acquisition unit is further configured for acquiring relevant information from the session information set.

In some optional implementations of the present embodiment, the user feature information comprises a user expression; and the second generation unit 503 is further configured for: generating the reply audio according to the text reply information; and generating the control parameter for the three-dimensional virtual portrait according to the user expression and the reply audio.

Referring to FIG. 6 below, a schematic structural diagram of an electronic device (e.g., the server in FIG. 1) 600 adapted to implement some embodiments of the present disclosure is shown. The electronic device shown in FIG. 6 is merely an example, and should not limit the functions and scope of use of embodiments of the present disclosure.

As shown in FIG. 6, the electronic device 600 may include a processing apparatus (e.g., a central processing apparatus, or a graphics processor) 601, which may execute various appropriate actions and processes in accordance with a program stored in a read only memory (ROM) 602 or a program loaded into a random access memory (RAM) 603 from a storage apparatus 608. The RAM 603 further stores various programs and data required by operations of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including a touch screen, a touch pad, a keyboard, a mouse, a camera, a microphone, an accelerometer, a gyroscope, or the like; an output apparatus 607 including a liquid crystal displayer (LCD), a speaker, a vibrator, or the like; a storage apparatus 608 including a tape, a hard disk, or the like; and a communication apparatus 609. The communication apparatus 609 may allow the electronic device 600 to exchange data with other devices through wireless or wired communication. While FIG. 6 shows the electronic device 600 having various apparatuses, it should be understood that it is not necessary to implement or provide all of the apparatuses shown in the figure. More or fewer apparatuses may be alternatively implemented or provided. Each block shown in FIG. 6 may represent an apparatus, or represent a plurality of apparatuses as required.

In particular, according to embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication apparatus 609, or may be installed from the storage apparatus 608, or may be installed from the ROM 602. The computer program, when executed by the processing apparatus 601, implements the above functions defined by the methods of some embodiments of the present disclosure.

It should be noted that the computer readable medium according to some embodiments of the present disclosure may be a computer readable signal medium or a computer readable medium or any combination of the above two. An example of the computer readable medium may include, but is not limited to: electric, magnetic, optical, electromagnetic, infrared, or semiconductor systems, apparatuses, elements, or a combination of any of the above. A more specific example of the computer readable medium may include, but is not limited to: electrical connection with one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above. In some embodiments of the present disclosure, the computer readable medium may be any tangible medium containing or storing programs, which may be used by, or used in combination with, a command execution system, apparatus or element. In some embodiments of the present disclosure, the computer readable signal medium may include a data signal in the base band or propagating as apart of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable medium. The computer readable medium is capable of transmitting, propagating or transferring programs for use by, or used in combination with, a command execution system, apparatus or element. The program codes contained on the computer readable medium may be transmitted with any suitable medium, including but not limited to: wireless, wired, optical cable, RF medium, etc., or any suitable combination of the above.

The computer readable medium may be included in the electronic device, or a stand-alone computer readable medium without being assembled into the electronic device. The computer readable medium stores one or more programs. The one or more programs, when executed by the electronic device, cause the electronic device to: receiving a video and an audio of a user that are sent by a client by means of instant communication; generating user feature information and text reply information according to the video and the audio; generating a control parameter and a reply audio for a three-dimensional virtual portrait according to the user feature information and the text reply information; generating a video of the three-dimensional virtual portrait by means of an animation engine based on the control parameter and the reply audio; and transmitting the video of the three-dimensional virtual portrait to the client by means of instant communication, for the client to present to the user.

A computer program code for executing operations in some embodiments of the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In a circumstance involving a remote computer, the remote computer may be connected to a user's computer through any network, including local area network (LAN) or wide area network (WAN), or be connected to an external computer (for example, connected through the Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logical functions. It should be further noted that, in some alternative implementations, the functions denoted by the blocks may also occur in a sequence different from the sequences shown in the figures. For example, any two blocks presented in succession may be executed substantially in parallel, or they may sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

The units involved in some embodiments of the present disclosure may be implemented by software or hardware, e.g., by one or more processors that execute software instructions stored on a non-transitory computer readable medium. The described units may also be provided in a processor, for example, described as: a processor including a receiving unit, a first generation unit, a second generation unit, a third generation unit, and a transmission unit. The names of the units do not constitute a limitation to such units themselves in some cases. For example, the receiving unit may be further described as “a unit configured to receive a video and an audio of a user that are sent by a client by means of instant communication.”

The above description only provides an explanation of embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

What is claimed is:

1. A method for generating information, comprising:
receiving a video and an audio of a user that are sent by a client by instant communication;
generating user feature information and text reply information according to the video and the audio;
generating a control parameter and a reply audio for a three-dimensional virtual portrait according to the user feature information and the text reply information;
generating a video of the three-dimensional virtual portrait based on the control parameter and the reply audio; and
transmitting the video of the three-dimensional virtual portrait to the client by instant communication, for the client to present to the user.

2. The method according to claim 1, wherein generating the user feature information and the text reply information according to the video and the audio comprises:
identifying the video to obtain the user feature information, and identifying the audio to obtain text information;
acquiring relevant information, the relevant information comprising historical user feature information and historical text information; and
generating the text reply information based on the user feature information, the text information and the relevant information.

3. The method according to claim 2, further comprising:
storing the user feature information and the text information in association into a session information set that is set for a current session.

4. The method according to claim 3, wherein acquiring the relevant information comprises:
acquiring the relevant information from the session information set.

5. The method according to claim 1, wherein the user feature information comprises a user expression; and
the generating the control parameter and the reply audio for the three-dimensional virtual portrait according to the user feature information and the text reply information comprises:
generating the reply audio according to the text reply information; and
generating the control parameter for the three-dimensional virtual portrait according to the user expression and the reply audio.

6. An apparatus for generating information, comprising:
at least one processor; and
a memory storing instructions, the instructions when executed by the at least one processor, cause the at least one processor to perform operations, the operations comprising:
receiving a video and an audio of a user that are sent by a client by means of instant communication;
generating user feature information and text reply information according to the video and the audio;
generating a control parameter and a reply audio for a three-dimensional virtual portrait according to the user feature information and the text reply information;
generating a video of the three-dimensional virtual portrait based on the control parameter and the reply audio; and
transmitting the video of the three-dimensional virtual portrait to the client by instant communication, for the client to present to the user.

7. The apparatus according to claim 6, wherein generating the user feature information and the text reply information according to the video and the audio comprises:
identifying the video to obtain the user feature information, and identifying the audio to obtain text information;
acquiring relevant information, the relevant information comprising historical user feature information and historical text information; and
generating the text reply information based on the user feature information, the text information and the relevant information.

8. The apparatus according to claim 7, the operations further comprising:
storing the user feature information and the text information in association into a session information set that is set for a current session.

9. The apparatus according to claim 8, wherein acquiring the relevant information comprises:
acquiring the relevant information from the session information set.

10. The apparatus according to claim 6, wherein the user feature information comprises a user expression; and
the generating the control parameter and the reply audio for the three-dimensional virtual portrait according to the user feature information and the text reply information comprises:
generating the reply audio according to the text reply information; and
generating the control parameter for the three-dimensional virtual portrait according to the user expression and the reply audio.

11. A non-transitory computer readable medium, storing a computer program, wherein the computer program, when executed by a processor, causes the processor to perform operations, the operations comprising:
receiving a video and an audio of a user that are sent by a client by means of instant communication;
generating user feature information and text reply information according to the video and the audio;
generating a control parameter and a reply audio for a three-dimensional virtual portrait according to the user feature information and the text reply information;
generating a video of the three-dimensional virtual portrait based on the control parameter and the reply audio; and
transmitting the video of the three-dimensional virtual portrait to the client by instant communication, for the client to present to the user.

12. The non-transitory computer readable medium according to claim 11, wherein generating the user feature information and the text reply information according to the video and the audio comprises:
identifying the video to obtain the user feature information, and identifying the audio to obtain text information;
acquiring relevant information, the relevant information comprising historical user feature information and historical text information; and
generating the text reply information based on the user feature information, the text information and the relevant information.

13. The non-transitory computer readable medium according to claim 12, the operations further comprising:
storing the user feature information and the text information in association into a session information set that is set for a current session.

14. The non-transitory computer readable medium according to claim 13, wherein acquiring the relevant information comprises:
acquiring the relevant information from the session information set.

15. The non-transitory computer readable medium according to claim 11, wherein the user feature information comprises a user expression; and
the generating the control parameter and the reply audio for the three-dimensional virtual portrait according to the user feature information and the text reply information comprises:
generating the reply audio according to the text reply information; and
generating the control parameter for the three-dimensional virtual portrait according to the user expression and the reply audio.
